(19) United States
(12) Patent Application Publication
(10) Pub. No.: US 2026/0233630 A1
(43) Pub. Date: Aug. 13, 2026

(54) METHOD AND SYSTEM FOR METERING ELECTRICITY TRANSMITTED TO ELECTRIC VEHICLES OVER A WIRELESS POWER TRANSFER SYSTEM

(71) Applicant: Electreon Wireless Ltd., Beit Yanai (IL)

(72) Inventor: Andreas WENDT, Köln (DE)

(73) Assignee: Electreon Wireless Ltd., Beit Yanai (IL)

(21) Appl. No.: 19/645,490

(22) Filed: Apr. 13, 2026

Related U.S. Application Data
(63) Continuation of application No. PCT/IL2024/050995, filed on Oct. 11, 2024.

(30) Foreign Application Priority Data
Oct. 13, 2023 (GB) 2315728.2

(51) Int. Cl. B60L 53/66; B60L 53/12; B60L 53/65; B60L 53/68; G06Q 20/10; G06Q 50/06; H02J 50/10; H02J 50/40; H02J 50/80

(52) U.S. Cl. CPC B60L 53/665; B60L 53/12; B60L 53/65; B60L 53/68; G06Q 20/102; H02J 50/40; H02J 50/80; B60L 2240/70; G06Q 50/06; H02J 50/10

(57) ABSTRACT

A method and system for metering electricity transmitted to electric vehicles over a wireless power transfer system. The system may include: an electric vehicle having an energy receiver; a management unit configured to drive electrical current to an energy transmitter withing a road section having a management communication unit; and a control center having a control unit, wherein the electric vehicle is operable to receive energy, at said the energy receiver, from the energy transmitter upon an identification of the electric vehicle, wherein the control unit is configured to measure an energy input into the at least management unit and further measure distribution of the energy input into the energy transmitter, and wherein the control center is configured to calculate an energy transmitted from the energy transmitter to the electric vehicle based on distribution of the energy input and identification of the electric vehicle.

### CROSS REFERENCE TO RELATED APPLICATIONS

This patent application is a Continuation of PCT Application No. PCT/IL2024/050995, international filing date Oct. 11, 2024, which claims the priority of GB Patent Application No. 2315728.2, filed on Oct. 13, 2023, which is incorporated herein by reference in its entirety.

### FIELD OF THE INVENTION

The present invention relates generally to wireless power transfer systems, and more particularly to metering of electricity transmitted to electric vehicles by such system.

### BACKGROUND OF THE INVENTION

Prior to setting forth a detailed description of the invention, the following term definitions are provided:

The term ‘electric vehicle’ as used herein refers generally to a vehicle powered solely, or in part, by electrical energy stored (e.g., chemically) in a battery, or the like. In the present context, an ‘electric vehicle’ moreover has provision for receiving (e.g., at coils disposed on the underside of the vehicle) a wirelessly induced electromotive force (i.e., voltage) that may be stored, or otherwise utilized to recharge the battery. For an electromagnetically induced voltage to occur, the vehicle (i.e., the ‘conductor’) may be moving relative to a magnetic field which is, for example, projected about the road upon which the vehicle is travelling. Alternatively, the magnetic field may be periodically varied (e.g., through use of alternating current) thereby inducing a voltage at the vehicle.

The term ‘road section’ as used herein refers generally to a portion of, for example, a highway or motorway which has been modified to comprise a medium for wirelessly transmitting power (i.e., a ‘power transmitter’). This may mean that the road comprises a plurality of coils embedded beneath the surface of the road section which are operable to emit a magnetic field. In typical arrangements, the medium (coils) may be connected to an alternating current source and may generate a varying magnetic field, thereby inducing a voltage in any proximate conductor. One possible approach to powering on-road electric vehicles via wireless power transfer is disclosed in US Patent Application Publication No. US2016/0339785 which is incorporated herein by reference in its entirety.

In order to carry out accurate metering of the consumed energy for billing purposes, measuring at the vehicle DC interface may be the obvious solution. This could be a sum signal of all receivers or multiple power meters. The advantage is that this is exactly what the customer gets. However, the disadvantage is that calibrated, high precision DC meters are very expensive, and their price may not drop in price drastically in the future.

Due to the often-prohibitive expense involved in wirelessly transmitting power to electric vehicles, there is a requirement to accurately produce bills associated with each individual user's usage. Typical approaches have entailed periodically (e.g., once per month) assessing an amount of power received by each vehicle and producing a bill corresponding to this amount. Such methods of metering and billing are however flawed and unduly susceptible to improper conduct by drivers and third parties. In particular, as there is no redundancy or secondary information source, it is possible for power reception values to be infiltrated and desirably modified (e.g., to a lower value to achieve a smaller bill) without being noticed. There may also be instances where particular components have failed, for example due to age or overuse, and have thereby (favorably or unfavorably) produced inaccurate readings.

Some workable solutions include providing a metering device on the vehicle side. While this solution may be very accurate, in some countries, regulations concerning electric vehicles may require having the metering functionality implemented on the road or infrastructure side.

### SUMMARY OF THE PRESENT INVENTION

In order to overcome the drawbacks of the presently available metering solutions, it is suggested, in some embodiments of the present invention, to measure the energy transmitted by the coils associated with a management unit, to the electric vehicles. Potentially by allocating the energy to specific vehicles based on relative measurements of currents flowing through each one of the coils and further based on the identification of the electric vehicle receiving the transmitted energy. This way, every portion of transmitted energy is accounted for on the transmitter side as it is being associated with a unique identification on the vehicle side. Each management unit then transmits the data for all electric vehicles energized through it and in a central location the accumulation of the energy transmitted to each electric vehicle takes place.

Some embodiments of the present invention provide a system for metering electricity transmitted to electric vehicles over a wireless power transfer system. The system may include the following elements: at least one electric vehicle having at least one energy receiver and a vehicle communication unit; at least one management unit configured to drive electrical current to at least one road section having at least one energy transmitter and a management communication unit; and a control center having at least one control unit and a communication unit, wherein said at least one electric vehicle is operable to receive energy, at said at least one energy receiver, from said at least one energy transmitter upon an identification of the at least one electric vehicle communicated between the vehicle communication unit and the communication unit, wherein the control unit is configured to measure an energy input into the at least management unit and further measure distribution of the energy input into the at least one energy transmitter, and wherein the control center is configured to calculate an energy transmitted from the at least one energy transmitter to the at least one electric vehicle based on said distribution of the energy input and the identification of the at least one electric vehicle.

Some embodiments of the present invention provide a method of metering electricity transmitted to electric vehicles over a wireless power transfer system, the method comprising: driving electrical current via a management unit having a communication unit, into at least one road section having at least one energy transmitter and a management communication unit; transmitting energy, by the at least one energy transmitter, to at least one receiver located on at least one electric vehicle which comprises a vehicle communication unit, upon an identification of the at least one electric vehicle communicated between the vehicle communication unit and the communication unit; measuring an energy input into the at least management unit and further measuring distribution of the energy input into the at least one energy transmitter; and calculating an energy transmitted from the at least one energy transmitter to the at least one electric vehicle based on said distribution of the energy input and the identification of the at least one electric vehicle

These and other advantages of the present invention are set forth in detail in the following description.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a block diagram illustrating non-limiting exemplary architecture of a network for electric vehicles in accordance with embodiments of the present invention;

FIG. 2 is a block diagram illustrating a more detailed architecture of a network for electric vehicles in accordance with embodiments of the present invention;

FIG. 3 is flowchart illustrating an exemplary process in accordance with embodiments of the present invention;

FIG. 4 is a graph illustrating an exemplary sampling process in accordance with embodiments of the present invention; and

FIG. 5 is a high-level flowchart illustrating a non-limiting exemplary method in accordance with embodiments of the present invention.

### DETAILED DESCRIPTION OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes it apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

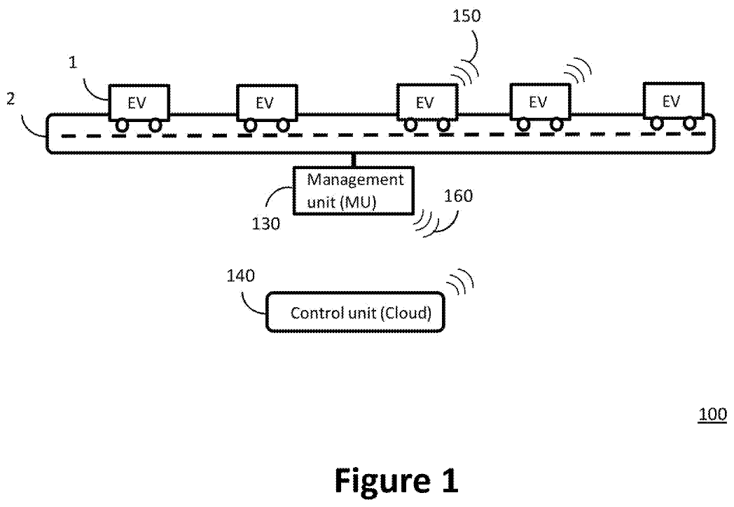

FIG. 1 is a block diagram illustrating non-limiting exemplary architecture of a network for electric vehicles according to embodiments of the invention. Any Wireless Power Transfer System (WPT) 100 implementing embodiments of the present invention may include the following main components: a management unit (MU) 130, coil segments 2 installed under the surface of the road and receivers installed on electric vehicles 1. In such a system one or more coil segments and associated cables are installed underground. The Management Unit is installed close to the charging system. One or more receivers are installed underneath an electric vehicle (EV). Multiple segments can be energized to charge multiple vehicles simultaneously. One EV may have more than one receiver (such as a bus with 3 receivers).

In accordance with embodiments of the present invention, a power metering network may be implemented on top of Wireless Power Transfer System (WPT) 100 and may include a plurality of electric vehicles each comprising a vehicle unit 1, a vehicle communications unit, and a power receiver attached, for example, to an underside of the vehicle. The plurality of electric vehicles may further travel upon a road section 2 having one or more power transmitters disposed, for example, underneath the surface of the road section. In some embodiments, each power receiver and power transmitter may comprise one or more wound or looped coils coupled, for example, to an alternating current source. In some arrangements, these coils may be operable to emit a static or varying magnetic field into a vicinity about the coils, for example around the road section or portions thereof. As each electric vehicle travels along road section 2, a magnetic field formed by power transmitters in road section 2 induces a voltage in each power receiver and is stored and/or converted by the electric vehicle into, for example, chemical energy in a battery. In alternative embodiments, the induced energy may be immediately used by an engine of the electric vehicle without storage.

In some embodiments, road section 2 may further comprise at least one management unit 130 and at least one management communications unit. Additionally, network 100 may further comprise a control center comprising at least one control unit 140 and at least one communications unit. In some embodiments, each of said vehicle units 110 may be operable to transmit a message 150 using said vehicle communications unit, to said control center via any appropriate transmission means, such as Wi-Fi, Bluetooth, or the like. Transmitted messages 150 may comprise data/information including the values equaling: the magnitude of energy received in the predefined period; and/or, the total magnitude of energy received by the electric vehicle up to that point.

In some embodiments, management unit 130 may be operable to calculate a total amount (i.e., magnitude) of energy transmitted by power transmitters in road section 2 to its respective electric vehicle by multiplying a known rate of transfer (i.e., power, or joules per second) by the recorded duration of the transfer. In some embodiments, the rate of current sampling may be in the range of KHz to MHz, as appropriate.

In some embodiments, management unit 130 may comprise a memory unit containing one or more flash memory units and one or more Static Random-Access Memory (SRAM) units. A value equaling the total magnitude of energy transmitted to the electric vehicle (i.e., the energy used over all journeys) may be retained and updated by the management unit 130 on the one or more flash memory units. A value equaling the magnitude of energy used in a predefined recording period (e.g., minutes, hours, days, months, or the like) may also be retained and updated by the management unit 130 on the one or more SRAM units. In some embodiments, the value equaling the total magnitude of energy transmitted to the electric vehicle may only be updated/altered by additions, said additions equaling the value for the magnitude of energy used in the predefined recording period. In some embodiments, the value equaling the magnitude of energy used in the predefined recording period is reset to a base/zero value at the end of each recording period.

In some embodiments, management unit 130 may be operable to record/calculate a value equaling the total amount (i.e., magnitude) of energy transmitted to specific vehicles from the road section 2 by multiplying a known rate of transfer (i.e., power, or joules per second) by the recorded duration of the transfer. In alternative embodiments, management unit 130 may be operable to directly record a magnitude of energy transmitted to respective vehicles, for example by using a current probe to record the current passed through the coils and/or by determining the strength of the magnetic field emanating from the coils and/or by calculating the total amount of energy transferred to the road section 120 and deriving therefrom a value of energy transmitted to specific vehicles. In some embodiments, the rate of current and/or magnetic field sampling may be in the range of KHz to MHz, as appropriate.

In some embodiments, management unit 130 may be operable to transmit a message 160 using said management communications unit, to the control center via any appropriate transmission means, such as Wi-Fi®, Bluetooth®, or the like. Transmitted messages 160 may comprise data/information including the values equaling: the magnitude of energy transmitted to specific vehicles in the predefined period.

Messages transmitted, 160 from each management unit 130 may take the following package form:

TABLE (1)

| MU Location | Unique ID Number | Additional Energy | Time |
|---|---|---|---|
| (GPS) | of electric vehicle | Transmitted (KW/Hr) | Stamp |
| 24bits | 48bits | 48bits | 42bits |

As can be seen in exemplary Table (1), the MU, which is identified by its location by Global Positioning System (GPS), records the amount of energy transmitted to each vehicle (identified by its a unique ID) with a time stamp allocated. This is an additional transmitted energy (aka the “delta”). The main control unit at the cloud receives the data from all MUs and accumulates the additional energy portions transmitted by each MU per electric vehicle over time. The amounts of energy transmitted from all energy transmitters of all management units may be accumulated to form accumulated energy received by each authorized electric vehicle.

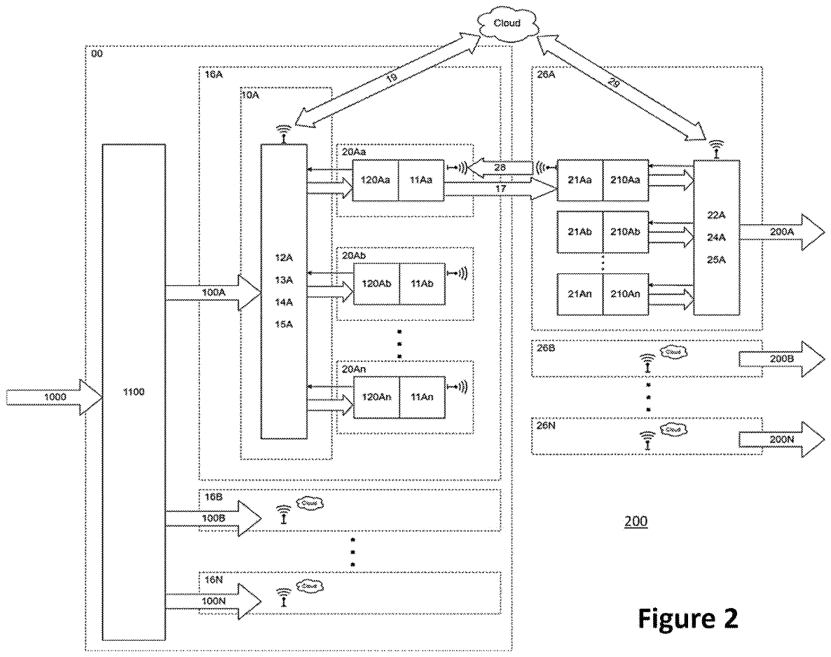

FIG. 2 is a block diagram illustrating a more detailed architecture of a network for electric vehicles in accordance with embodiments of the present invention. Wireless Power Transfer System (WPT) 200 may include two different layers of communication. The high-level communication of the infrastructure and the vehicle to a cloud-based management system as well as low-level, real time PTPS/PTPC communication between the transmitters and the receivers.

According to some embodiments, the first one is suitable for monitoring, management, load distribution, metering, and billing, whereas real-time communications are needed for power activation, identification and vehicle-controlled power regulation. High-level communication I implemented through 19, 29 via cloud and low-level communication 28 via PTPS/PTPC channels.

According to some embodiments of the present invention, Electric Road System (ERS) 00 may include an ERS section power distribution 1100 which is fed by electricity from grid connection 1000 and further connected via supply network 100 to respective management units (MU) 10A (for respective segments a . . . n). Supply device 16A may include an MU 10A which may be associated with the following components: a segment driver 12A which acts as supply power electronics of primary device, a supply power circuit (SPC) of primary device 13A, a slave supply equipment communication controller (“SECC-S” of primary device 14A, and a supply device P2PS controller of primary device 15A.

According to some embodiments of the present invention, MU10A drives current into respective transmitter device 20Aa-20An each including primary coil compensation, impedance matching and U-I-gyrator 120Aa-120An and though respective primary coil of segment 11Aa . . . 11An of DWPT-installation, providing power to one or more vehicles via magnetic flux being wireless power flow of supply device 17. Supply device 16B-16N are similar to supply device 16A (detailed components not shown here).

According to some embodiments of the present invention, on EV device of vehicle 26A, secondary device of vehicle implementing receivers 21Aa-21An each connected to respective secondary device compensation, impedance matching and Rectifier 210Aa-210An which are connected to respective power electronics/-control of vehicle 22A, EV power circuit (EVPC) of vehicle 24A, and EV device P2PS controller of vehicle 25A all outputting RESS of vehicle 200A, 200B . . . 200N. Similarly, EV device of vehicle 26B-26N are similar connected (components not shown here).

According to some embodiments of the present invention, metering the energy that has been consumed by the electric vehicles may be implemented by MU Input measurement followed by relative current distribution of all coils associated with the MU. Specifically, it may be possible to measure the input power to an MU, either being AC or DC (100X) and then measure only relative currents to the multiple segments (Interconnection between unit 10X to 120Xy). The ratio or the breakdown between the different electric currents may thus infer the amount of energy transmitted at each electric vehicle.

Advantageously, embodiments of the present invention require only single very precise (absolute) power measurement per MU and then only relative current sensors are needed (as all segment drivers operate at the same voltage level).

Embodiments of the present invention provide therefore a solution for cost saving, as high precision (absolute) current sensors suffer from temperature changes. It is then possible to retrieve only the relative distribution of current this could be quite cost effective.

By way of example, embodiments of the present invention may be very cost effective: for example, 10,000 km of highway in France may require 100 k high precision power meters, total number of vehicles is ~40M. This means the availability of the solution in accordance with some embodiments of the present invention reduces the number of expensive sensors by the factor of 400.

Alternatively, embodiments of the present invention may also be implemented with a precise power meters per coil or per two or more coils. This solution may be viable if cost of these power meters drops in the future and can still be regarded as advantageous for several applications and for regulatory purposes over having the meter on the vehicle side.

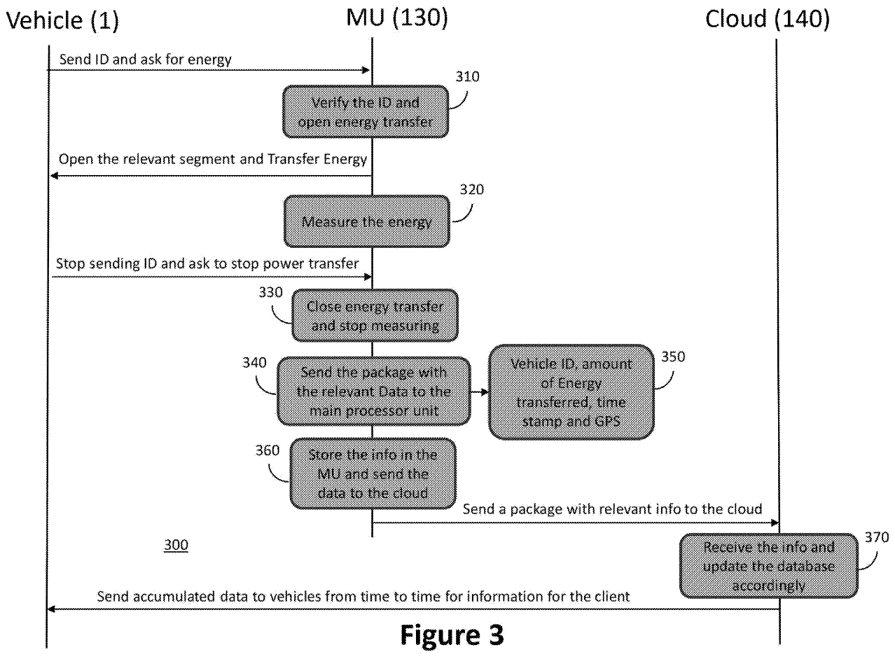

FIG. 3 is flowchart illustrating an exemplary process 300 of metering the energy transmitted to electric vehicles by energy transmitters powered by management units operative on a system shown in FIG. 1 according to embodiments of the invention.

According to embodiments of the invention, whenever an electric vehicle 1 comes withing the coverage of a specific management unit (MU) 130, electric vehicle sends the MU its unique ID with a request for energy. The MU 130 upon receipt of the request, verifies the ID and opens energy transfer 310 by powering the energy transmitters of road section 2 located right below electric vehicle 1. Once energy transmitters are powered, the transmitted energy is measured 320. This can be done as explained above, either by directly measuring the energy powering the relevant energy transmitter below the vehicle or by measuring the energy driven by the MU and further measuring the current driven into the each of the energy transmitters and allocating the energy based on the relative measurement of the currents. Once electric vehicle 1 stops sending the ID and requests to stop power transfer, MU 130 closes the energy transfer and stops the measuring 330. Then, MU 130 sends a message to cloud 140, 340, possibly in the package format of Table (1) described above, where message 350 includes at least: vehicle ID, amount of energy transmitted to it, time stamp, and GPS location of MU 130. The message can be also stored and then sent 360. When cloud 140 receives the message from MU 130, it updates the metering database accordingly 370. More specifically control unit at cloud 140 accumulates for each vehicle on the database the energy transmitted to it and thus keeps an updated metering record for all registered electric vehicles with regard to the amount of energy consumed by them since they became subscribers.

According to some embodiments of the present invention, since it is technically challenging for the MU to verify the unique ID of each vehicle versus information relating to authorized vehicles stored on the cloud, it is suggested by inventors of the present invention to use GPS data of vehicles in order to limit to potential subscribers in a vicinity of a specific MU.

For example. In a case that there are 40 million electric vehicles which are subscribers and are effectively authorized electric vehicles, it would be able to periodically update each MU about a much smaller group of electric vehicles, for example 4 thousands that are located within a few kilometers form the MU and are therefore should be potential users in the immediate future. By limiting the list of unique ID to a few thousands within a predefined time duration the MU can easily and quickly determine whether an electric vehicle requesting electricity with a certain unique ID is authorized or not.

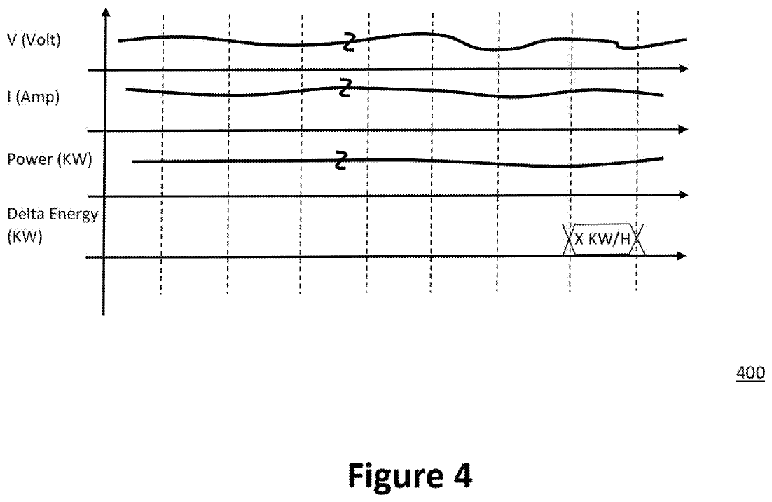

FIG. 4 is a graph illustrating an exemplary sampling process 400 according to embodiments of the inventions with reference to the system shown in FIG. 1. After a message is transmitted 150 from the or each vehicle unit 1, control unit 140 may be operable to compare the value of the total magnitude of energy received by the electric vehicle to pre-existing and/or known values for the total magnitude of energy transmitted and/or the total magnitude of energy received. In some embodiments, these pre-existing and/or known values may be obtained from the or each management unit 130 via transmission 160. In alternative embodiments, these pre-existing and/or known values may be retained from previous transmissions 150 between the vehicle unit 1 and control unit 140. In the event that the values are identical, the control unit 140 may instruct the vehicle unit 1 to add the value for the magnitude of energy received in that predefined recording period to the value for the total magnitude of energy received by the electric vehicle up to that point. Vehicle unit 1 may then also be instructed to reset the value for the magnitude of energy received in that predefined recording period to a base/zero value and start a new recording period. In the event that the values are not identical, the control unit 140 may transmit corrected data/values to the vehicle unit 1 and instruct vehicle unit 1 to update the incorrect data/value with the correct one. Control unit 140 may also flag/indicate a potential for fraud and/or component failure. This may comprise a warning and/or alert and may be presented to one or more of: a user of the electric vehicle; and a system administrator.

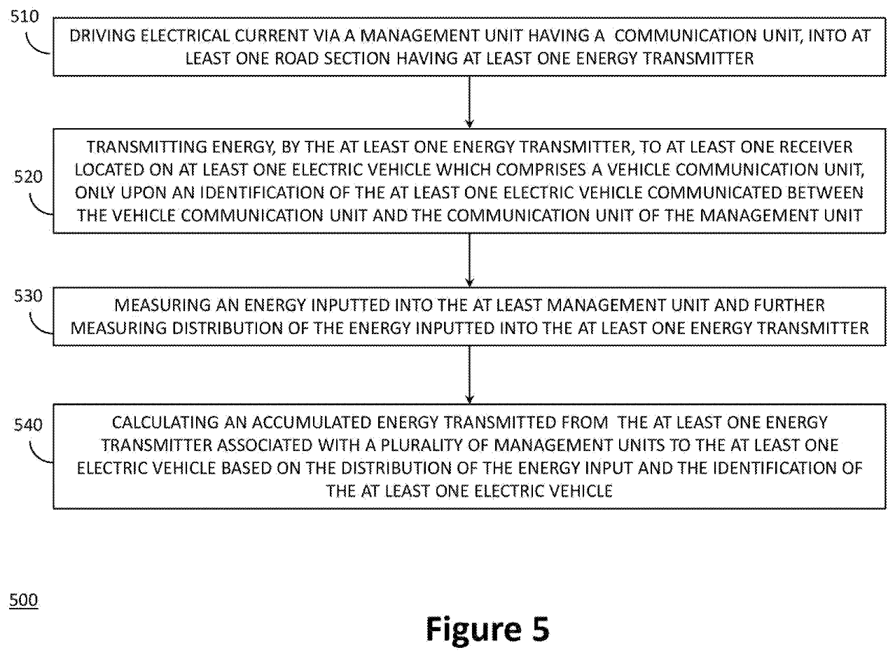

FIG. 5 is a high-level flowchart illustrating a method of metering electricity transmitted to electric vehicles over a wireless power transfer system, according to embodiments of the invention. Method 500 may include the steps of: driving electrical current via a management unit having a communication unit, into at least one road section having at least one energy transmitter 510; transmitting energy, by the at least one energy transmitter, to at least one receiver located on at least one electric vehicle which comprises a vehicle communication unit, only upon an identification of the at least one electric vehicle communicated between the vehicle communication unit and the communication unit of the management unit 520; measuring an energy inputted into the at least management unit and further measuring distribution of the energy inputted into the at least one energy transmitter 530; and calculating an accumulated energy transmitted from a plurality of management units each associated with the at least one energy transmitter to the at least one electric vehicle based on: said distribution of the energy input and said identification of the at least one electric vehicle 540.

In some embodiments, said at least one electric vehicle may further comprise a vehicle control unit arranged to: produce said record of said magnitude of energy received at said at least one energy receiver within at least one predefined period; store, in a vehicle memory unit, said record of said magnitude of energy received within said at least one predefined period; retain, in said vehicle memory unit, a record of a total cumulative magnitude of energy received; and, transmit to said control center, using said vehicle communication unit at the end of said at least one predefined period, said record of said magnitude of energy received and said record of said total cumulative magnitude of energy received.

In some embodiments, said at least one road section may further comprise a management control unit arranged to: produce said record of said magnitude of energy transmitted to said at least one energy transmitter in said road section within said at least one predefined period; and transmit to said control center, using said management communication unit at the end of said at least one predefined period, said record of said magnitude of energy transmitted with respective identification of the electric vehicle to which the energy was transmitted, possibly with the corresponding time stamp.

In some embodiments, each of said at least one electric vehicles may be associated with a use account, wherein each of said user accounts is periodically charged an amount corresponding to energy received by the associated electric vehicle.

In some embodiments, the identification of the electric vehicle before transmitting energy thereto is carried out by a unique ID associated with each one of the electric vehicles and wherein the management unit is informed of all unique ID associated with each one of the electric vehicles which are authorized to request energy transfer.

In some embodiments, the identification further comprises providing the management unit with a subset of the unique ID of the electric vehicles which are located within a predefined range from the management unit. Advantageously, limiting each management unit to unique IDs of electric vehicles in its proximity greatly reduces the complexity of the identification process and the latency involved so as to provide a practical solution to metering on the management unit side.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described herein above may be combined or otherwise coexist in embodiments of the invention.

It is to be understood that the phraseology and terminology employed herein is not to be construed as limiting and are for descriptive purposes only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional element.

It is to be understood that where the claims or specification refer to “a” or “an” element, such reference is not construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A system for metering electricity transmitted to electric vehicles over a wireless power transfer system, the system comprising:
at least one electric vehicle having at least one energy receiver and a vehicle communication unit;
at least one management unit configured to drive electrical current to at least one energy transmitter located within at least one road section having a management communication unit; and
a control center having at least one control unit and a control communication unit,
wherein said at least one electric vehicle is operable to receive energy, at said at least one energy receiver, from said at least one energy transmitter only upon an identification of the at least one electric vehicle communicated between the vehicle communication unit and the management communication unit,
wherein the management unit is configured to measure an energy inputted into the at least management unit and further measure distribution of the energy inputted into the at least one energy transmitter, and
wherein the control center is configured to calculate an accumulated energy transmitted from a plurality of management units each associated with the at least one energy transmitter to the at least one electric vehicle based on: said distribution of the energy input and said identification of the at least one electric vehicle.

2. The system of claim 1, wherein measuring the energy input into the at least management unit is carried out using a high precision energy measurement device and wherein the measuring the distribution of the energy input into the at least one energy transmitter is carried out using a current measurement device connected in series to each one of the at least one energy transmitters.

3. The system of claim 2, wherein the control center is configured to calculate the energy transmitted from the at least one energy transmitter to the at least one electric vehicle further by allocating an amount of energy based on a relative current distributed to each one of the at least one energy transmitters.

4. The system of claim 1, wherein the distribution of the energy input into the at least one energy transmitter is measured using an energy measurement device connected to each one of the at least one energy transmitters.

5. The system of claim 1, wherein said control unit is arranged to:
i) receiving, from each one of a plurality of management units, the energy transmitted from the at least one energy transmitter to the at least one electric vehicle within at least one predefined period;
ii) store, in a memory unit, said energy transmitted from the at least one energy transmitter to the at least one electric vehicle within at least one predefined period;
iii) retaining, in the memory unit, a record of a total cumulative energy transmitted from the at least one energy transmitter to the at least one electric vehicle over the at least one predefined period.

6. The system of claim 1, wherein each of said at least one electric vehicle is associated with a user account, and wherein each of said user accounts is periodically charged an amount corresponding to energy transmitted via the at least one energy transmitter.

7. The system of claim 1, wherein the identification is carried out by a unique ID associated with each one of the electric vehicles and wherein the management unit is informed of all unique ID associated with each one of the electric vehicles which are authorized to request energy transfer.

8. The system of claim 7, wherein the identification further comprises providing the management unit with a subset of the unique ID of the electric vehicles which are located within a predefined range from the management unit.

9. The system of claim 1, wherein the management unit is configured to transmit to the control center a message including: (i) a location of the management unit, (ii) a unique ID number of the electric vehicle, (iii) an additional amount of energy transmitted to the electric vehicle, and (iv) a time stamp.

10. The system of claim 9, wherein the control center is configured to accumulate, over time and from a plurality of management units, the additional amounts of energy transmitted to the electric vehicle to form an accumulated energy value for the electric vehicle.

11. A method of metering electricity transmitted to electric vehicles over a wireless power transfer system, the method comprising:
driving electrical current via a management unit having a communication unit, into at least one energy transmitter located in at least one road section having a management communication unit;
transmitting energy, by the at least one energy transmitter, to at least one receiver located on at least one electric vehicle which comprises a vehicle communication unit, upon an identification of the at least one electric vehicle communicated between the vehicle communication unit and the communication unit,
measuring an energy input into the at least management unit and further measuring distribution of the energy input into the at least one energy transmitter, and
calculating an energy transmitted from the at least one energy transmitter to the at least one electric vehicle based on said distribution of the energy input and the identification of the at least one electric vehicle.

12. The method of claim 11, wherein the measuring of the energy input into the at least management unit comprises using a high precision energy measurement device, and wherein the measuring the distribution of the energy input into the at least one energy transmitter comprises using a current measurement device connected in series to each one of the at least one energy transmitters.

13. The method of claim 12, wherein the calculating of the energy transmitted from the at least one energy transmitter to the at least one electric vehicle comprises allocating an amount of energy based on a relative current distributed to each one of the at least one energy transmitters.

14. The method of claim 11, wherein the distribution of the energy input into the at least one energy transmitter comprises using an energy measurement device connected to each one of the at least one energy transmitters.

15. The method of claim 11, further comprising:
i) receiving from each one of a plurality of management units, the energy transmitted from the at least one energy transmitter to the at least one electric vehicle within at least one predefined period;
ii) storing, in a memory unit, said energy transmitted from the at least one energy transmitter to the at least one electric vehicle within at least one predefined period; and
iii) retaining, in the memory unit, a record of a total cumulative energy transmitted from the at least one energy transmitter to the at least one electric vehicle over the at least one predefined period.

16. The method of claim 11, wherein each of the at least one electric vehicle is associated with a user account, wherein the method further comprising is periodically charging each of said user accounts with an amount corresponding to energy transmitted via the at least one energy transmitter.

17. The method of claim 11, wherein the identification comprises using a unique ID associated with each one of the electric vehicles, and further comprises informing the management unit of all unique IDs associated with electric vehicles authorized to request energy transfer.

18. The method of claim 17, wherein the identification further comprises providing the management unit with a subset of the unique IDs of the electric vehicles that are located within a predefined range from the management unit.

19. The method of claim 11, further comprising transmitting to the control center a message including: (i) a location of the management unit, (ii) a unique ID number of the electric vehicle, (iii) an additional amount of energy transmitted to the electric vehicle, and (iv) a time stamp.

20. The method of claim 19, further accumulating over time and from a plurality of management units, the additional amounts of energy transmitted to the electric vehicle to form an accumulated energy value for the electric vehicle.
